(19) United States
(12) Patent Application Publication
(10) Pub. No.: US 2024/0200956 A1
(43) Pub. Date: Jun. 20, 2024

(54) NAVIGATION THROUGH REAL-TIME STREET VIEW

(71) Applicant: INTERNATIONAL BUSINESS MACHINES CORPORATION, ARMONK, NY (US)

(72) Inventors: Chun-Sheng Chung, Taipei (TW); Yu-Ning Hsu, Taipei City (TW); Zen-Jerr Hong, Taipei (TW); Tien Yu Chu, Taipei (TW)

(21) Appl. No.: 18/065,823

(22) Filed: Dec. 14, 2022

(51) Int. Cl. G01C 21/34; G01C 21/36

(52) U.S. Cl. CPC G01C 21/3461; G01C 21/3602; G01C 21/3617; G01C 21/3629; G01C 21/3638; G01C 21/3644; G01C 21/3647; G01C 21/3691

(57) ABSTRACT

According to one embodiment, a method, computer system, and computer program product for real-time navigation is provided. The embodiment may include capturing one or more visual input streams. The embodiment may also include collecting data, including location data and a collected visual input stream from the one or more visual input streams. The embodiment may further include identifying items from the collected visual input stream. The embodiment may also include determining an optimal route based on the collected data. The embodiment may further include providing the optimal route to a user based on a context of the identified items.

### BACKGROUND

The present invention relates generally to the field of computing, and more particularly to navigation systems.

Navigation systems use technologies such as the Global Positioning System (GPS), geofencing, augmented reality, and data analytics to help users navigate the world. Particularly, such systems may help users browse data-enabled maps, find convenient routes between one point and another, and better understand the world around them. Navigation systems may also assist in navigation for devices that operate without a user, such as self-driving vehicles.

### SUMMARY

According to one embodiment, a method, computer system, and computer program product for real-time navigation is provided. The embodiment may include capturing one or more visual input streams. The embodiment may also include collecting data, including location data and a collected visual input stream from the one or more visual input streams. The embodiment may further include identifying items from the collected visual input stream. The embodiment may also include determining an optimal route based on the collected data. The embodiment may further include providing the optimal route to a user based on a context of the identified items.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for navigation through real-time street view.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to navigation systems. The following described exemplary embodiments provide a system, method, and program product to, among other things, provide real-time navigation instructions to users based on context. Therefore, the present embodiment has the capacity to improve the technical field of navigation systems by collecting and using contextual information to provide more meaningful directions to users.

As previously described, navigation systems use technologies such as GPS, geofencing, augmented reality, and data analytics to help users navigate the world. Particularly, such systems may help users browse data-enabled maps, find convenient routes between one point and another, and better understand the world around them. Navigation systems may also assist in navigation for devices that operate without a user, such as self-driving vehicles.

Navigation systems may be used to provide users with a route from one location to another based on distances, traffic information, and other map-related information. However, directions based on distances and street names may be difficult for users to follow. As such, it may be advantageous to visually recognize real-world objects and locations, and provide users with contextual directions based on those objects and other contextual information.

According to one embodiment, a method for navigation through a real-time street view is provided. The method may involve capturing a visual input stream and other data. That data may then be collected to assist in better navigation. The method may then involve recognizing objects and locations in the input stream. The collected data may be used to determine an optimal route for a user to take. Finally, the route may be provided to the user based on the context of recognized objects or locations.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

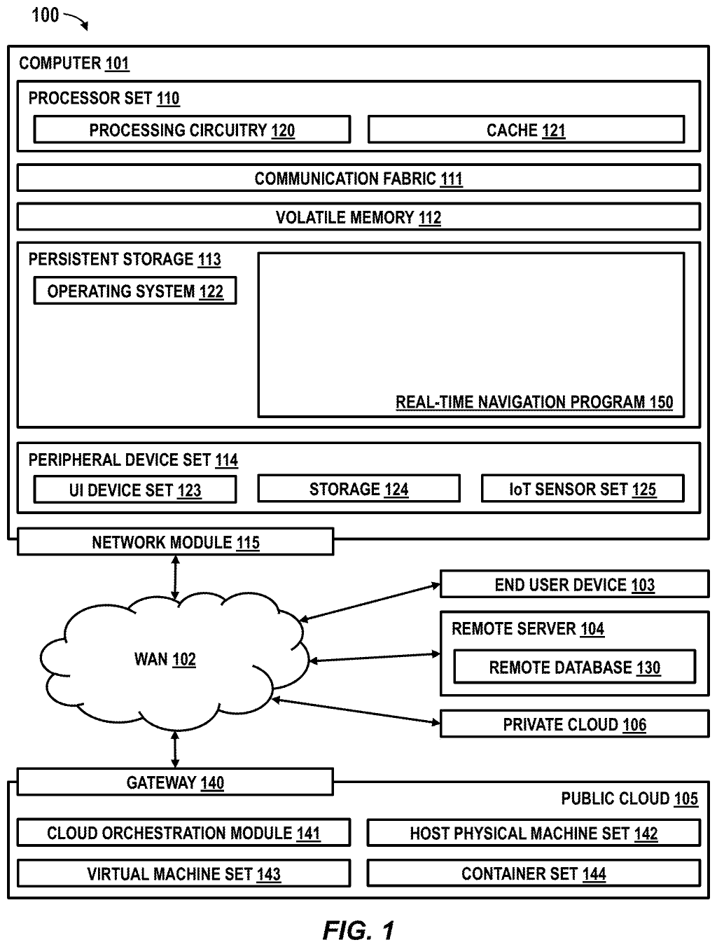

Referring now to FIG. 1, computing environment 100 contains an example of an environment for the execution of at least some of the computer code involved in performing the inventive methods, such as real-time navigation program 150. In addition to real-time navigation program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and real-time navigation program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed conversation is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in real-time navigation program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in real-time navigation program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The real-time navigation program 150 may capture a visual input stream and other data. The captured data may then be collected, as on a server. The real-time navigation program 150 may recognize items in the visual input stream, such as businesses or other notable locations and objects. The collected data may be used to determine an optimal route for a user. The route may then be provided to a user based on the context of recognized items.

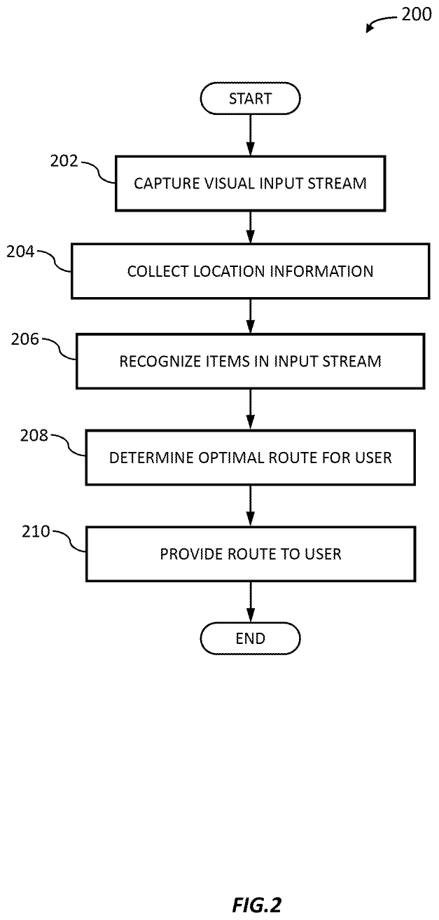

Furthermore, notwithstanding depiction in computer 101, real-time navigation program 150 may be stored in and/or executed by, individually or in any combination, end user device 103, remote server 104, public cloud 105, and private cloud 106. The real-time navigation method is explained in more detail below with respect to FIG. 2.

Referring now to FIG. 2, an operational flowchart for a process for real-time contextual navigation 200 is depicted according to at least one embodiment. At 202, the real-time navigation program 150 captures data, including at least one visual input stream. Capturing a visual input stream may include recording video or photographs using a camera. Other types of data may include geolocation data, audio data, and data about a device involved in real-time navigation.

In at least one embodiment, recording a visual input stream may be performed using a camera. A camera may include a vehicle camera, a smart phone camera, tablet camera, or other camera on a computing device, a camera built into a virtual reality (VR) device, or a peripheral camera, which may be communicatively coupled or paired with other devices, or communicate directly with a server that collects data at 204. The real-time navigation program 150 may capture more than one input stream, and may combine video or photographs from more than one source into one stream.

Captured data may further include geolocation data, such as that collected by GPS or another global navigation system, or using a geofence. Geolocation data may be captured repeatedly or continuously over time, creating a stream of locations. Additionally, captured data may include audio data. Audio data may be synchronized to a video stream.

Furthermore, captured data may include metadata, including metadata about a visual or audio stream, geolocation data, or a device. A device may be a vehicle, smart phone, tablet, laptop, VR device, peripheral device, or any other computing device. Metadata may include a resolution of a device's camera, data about a device's network connections, data about a device's storage capacity, data about a device's display, or data about a vehicle, such as a model number, a speed, a direction, a gas level, a battery level, or maintenance information.

Then, at 204, the real-time navigation program 150 collects location data, including the data captured at 202. Location data may further include map data, traffic data, and other data relevant to location or to real-time navigation. Data may be collected from devices participating in real-time navigation, public or private data sources, and internal or external databases. Data may be collected and kept securely on a traditional server, in a cloud database, in a distributed database, or on an edge server, or in any other context where data may be stored.

Data may include data captured at 202, including visual input streams, audio data, geolocation data, and metadata. Data may be collected from devices according to opt-in procedures. The real-time navigation program 150 may exclude data that is found to be unnecessary for real-time navigation.

In at least one embodiment, location data may further include map data, traffic data, street view data, public transit data, data about local businesses, weather data, and any other data that may relate to the general location where real-time navigation is being performed. Alternatively, location data may include data about devices or vehicles, including devices and vehicles used in real-time navigation, and devices and vehicles identified at 206. For example, location data may include a set of vehicle logos that may be used in image recognition at 206.

In another embodiment, location data may further include any other data that may be relevant to or helpful in real-time navigation. For example, the real-time navigation program 150 may collect data reflecting exchange rates between currencies and restaurant price norms to display an abstract representation of the price of a local restaurant, such as a number of currency symbols between one symbol (to signify an inexpensive meal) and four symbols (to signify a very expensive meal).

Data may be collected from a variety of sources, including devices used to capture data at 202, connected devices, other servers collecting similar data, public and private Application Programming Interfaces (APIs) and data sets, or any other service or source from which data can be obtained. Data may be collected from one or more devices, corresponding to one or more users. Data may be collected from sufficiently many devices so as to compare patterns of similar routes that different users take.

Next, at 206, the real-time navigation program 150 recognizes at least one item in the visual input stream. Items may include buildings, signs, streets, landmarks, vehicles, or any other object or location a user may recognize. Items may be recognized using visual recognition techniques, location matching, or other techniques based on collected data. Items may be recognized locally, as on a user's device, or at a higher level, as on a server where data is collected.

In at least one embodiment, items include buildings, signs, streets, landmarks, parks, vehicles, billboards, or any other object or location a user may recognize, or any part of such an item, or collection of such an item. For example, the real-time navigation program 150 may recognize a hardware store by a sign bearing its name. Alternatively, an item may include the statue at the northwest corner of an intersection. As another alternative, an item may be an acutely-angled corner, or a street running diagonal to the street the user is currently on.

In a further embodiment, an item may be recognized using visual recognition techniques. For example, if an item is a vehicle, the real-time navigation program 150 may recognize the vehicle, with a symbol representing a brand logo, a silhouette of the vehicle corresponding to a known silhouette of a certain model found in a database of vehicle models, and a color that is known to correspond to a particular set of vehicle models, and thereby determine the make and model of the vehicle. Colors may be determined using techniques like a color grabber, or relative techniques that account for variations in cameras and lighting, such as by comparing colors to other, known colors.

Visual recognition techniques may include comparison between two visual input streams, or a visual input stream and a street view. For example, if a restaurant has a triangular roof, and sits next to two rectangular buildings, visual recognition may match the shapes of the building between a visual input stream and a street view. Further still, visual recognition techniques may include text recognition, allowing the real-time navigation program 150 to read items such as signs, license plates, and billboards. Visual recognition techniques may also include gauging a real-world distance between two points, or between a camera and a particular point in the visual input.

Comparison and other visual recognition techniques may involve a process of artificial intelligence, including training a machine learning algorithm and use of artificial neural networks.

In another embodiment, items may be recognized using location techniques, such as location matching, GPS, geofencing, and gauging distances as described above. Items may be recognized by a combination of visual recognition and location techniques. For example, if visual recognition techniques allow the real-time navigation program 150 to identify one building, location techniques may use map data to match the location of the building next door to the first building with a location in map data corresponding to a building next door to the first building.

Then, at 208, the real-time navigation program 150 determines an optimal route for a user based on the collected location data. Determining an optimal route may be performed by matching route similarities, or using other known techniques, including pathfinding algorithms, graph theory, and optimization algorithms. An optimal route may be the one that reaches a target location by the shortest distance, the lowest fuel consumption, a most scenic route, or a weighted combination of optimization factors, or a route determined using artificial intelligence techniques.

In at least one embodiment, the real-time navigation program 150 may determine an optimal route in response to a request from a user. Alternatively, the real-time navigation program 150 may determine optimal routes repeatedly, continuously, or in response to a change in any relevant factor, such as changing traffic or weather conditions, or new data from other users taking similar routes. The optimal route may be determined in real-time. Alternatively, a route may be predetermined and optimized, repeatedly or continuously, in real time.

A route may be determined by matching route similarities. For example if a user is seeking the optimal route between point A and point D, determining a route may be performed by combining routes other users have taken from point A to B, B to C, and C to D, or by comparing that combined route to another route determined using other known techniques. Route similarity may include matching routes with nearby start points or destinations, and use of techniques such as graph theory. Comparison to the routes other users have taken may indicate, for example, that a certain road appears to be closed or impassable, or that a shorter path exists.

Determining a route may further include use of other known techniques, including pathfinding algorithms, graph theory, optimization algorithms, including greedy algorithms, and artificial intelligence techniques for finding routes. Alternatively, finding a route may be determined by external sources, such as by querying an external pathfinding API.

Determining a route may include identifying multiple routes and comparing them according to optimization factors to select the optimal route from many suggested routes. Determining an optimal route may further include combining multiple routes into one better-optimized route.

An optimal route may be the one that reaches a target location by the shortest distance, the lowest fuel consumption, a most scenic route, a route with the lowest tolls, or a weighted combination of optimization factors. For example, an optimal route may be a weighted minimal route where each minute spent traveling is weighted as one point, each dollar spent on tolls is weighted as five points, and the distance may not exceed the range of a vehicle based on its current battery level.

Alternatively, an optimal route may be selected by artificial intelligence techniques, including machine learning and artificial neural networks. For example, an artificial intelligence algorithm may collect feedback about a variety of routes to train a machine learning model for determining which routes users are most likely to prefer.

Next, at 210 the real-time navigation program 150 provides the route to the user based on context. Providing a route may include displaying an augmented reality overlay, street view, or map navigation view; providing a list of directions; providing an audio recording describing directions; or providing a Universal Resource Indicator (URI) to a route. Context may include the captured visual input stream, collected location data, and recognized items.

In at least one embodiment, a route may be provided as an augmented reality overlay. An augmented reality overlay may include information, symbols, figures, and color coding over a visual input stream. Such information may be displayed as text describing recognized items or directions, arrows indicating directions, or any other symbol or figure that may enhance the provided route with helpful or explanatory context. Alternatively, a route may be provided in a street view or map navigation view, portraying similar information, or portraying imagery from the visual input stream.

In another embodiment, a route may be provided as a text-based list of directions, or recorded audio of directions. Recorded audio may be segmented by steps of directions. Such directions may be provided based on context described below, and may utilize techniques of natural language processing to prepare natural language descriptions based on context. For example, rather than saying “turn left in 1.1 miles,” a natural language description based on context may direct a user to “turn left at the large stone statute of a horse.” A direction may further include warnings, such as a warning that a given turn will take a driver into a one way street, that a sidewalk ends for a pedestrian user, or that a bike lane ends for a biking user.

Providing a route may include combining more than one of the above techniques. For example, providing a route may include combining an augmented reality overlay with recorded audio directions segmented by steps of directions.

Context may include the captured visual input stream, collected location data, and recognized items. More specifically, context and the ideal natural language description for a direction may be determined using collected location data and recognized items. For example, if collected location data shows that most houses on a street are blue and gray and brown, and only one is red, a direction may read “turn right into the alley just after the red house.” Alternatively, a list of directions may include context in the form of photographs or still frames taken from previous visual input streams for similar routes.

In a further embodiment, providing a route may include providing a URI to a route. A user may be able to share a route, such as by sharing the URI to the route.

Providing a route to a user may include capturing or collecting feedback from the user. Feedback may then be used in machine learning to, for example, determine better routes, better identify items, provide better directions, provide better context in directions, or provide better natural language descriptions of context. Alternatively, feedback may be provided to a user, such as an administrative user or a developer who may further refine real-time navigation.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
capturing one or more visual input streams;
collecting data, including location data and a collected visual input stream from the one or more visual input streams;
identifying items from the collected visual input stream;
determining an optimal route based on the collected data; and
providing the optimal route to a user based on a context of the identified items.

2. The method of claim 1, wherein identifying items is performed using visual recognition techniques.

3. The method of claim 1, wherein the identified items include a building or landmark.

4. The method of claim 1, wherein the optimal route is selected by a comparison to similar routes from the collected data.

5. The method of claim 1, wherein providing the optimal route includes providing an augmented reality overlay over a street-level visual input stream from the one or more visual input streams.

6. The method of claim 1, wherein providing the optimal route includes a natural language explanation of the context of the identified items.

7. The method of claim 1, wherein the captured location data includes geolocation data obtained using a global navigation system and a geofence.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
capturing one or more visual input streams;
collecting data, including location data and a collected visual input stream from the one or more visual input streams;
identifying items from the collected visual input stream;
determining an optimal route based on the collected data; and
providing the optimal route to a user based on a context of the identified items.

9. The computer system of claim 8, wherein identifying items is performed using visual recognition techniques.

10. The computer system of claim 8, wherein the identified items include a building or landmark.

11. The computer system of claim 8, wherein the optimal route is selected by a comparison to similar routes from the collected data.

12. The computer system of claim 8, wherein providing the optimal route includes providing an augmented reality overlay over a street-level visual input stream from the one or more visual input streams.

13. The computer system of claim 8, wherein providing the optimal route includes a natural language explanation of the context of the identified items.

14. The computer system of claim 8, wherein the captured location data includes geolocation data obtained using a global navigation system and a geofence.

15. A computer program product, the computer program product comprising:
one or more computer-readable tangible storage medium and program instructions stored on at least one of the one or more tangible storage medium, the program instructions executable by a processor capable of performing a method, the method comprising:
capturing one or more visual input streams;
collecting data, including location data and a collected visual input stream from the one or more visual input streams;
identifying items from the collected visual input stream;
determining an optimal route based on the collected data; and
providing the optimal route to a user based on a context of the identified items.

16. The computer program product of claim 15, wherein identifying items is performed using visual recognition techniques.

17. The computer program product of claim 15, wherein the identified items include a building or landmark.

18. The computer program product of claim 15, wherein the optimal route is selected by a comparison to similar routes from the collected data.

19. The computer program product of claim 15, wherein providing the optimal route includes providing an augmented reality overlay over a street-level visual input stream from the one or more visual input streams.

20. The computer program product of claim 15, wherein providing the optimal route includes a natural language explanation of the context of the identified items.
